(19) United States
(12) Patent Application Publication
(10) Pub. No.: US 2017/0228691 A1
(43) Pub. Date: Aug. 10, 2017

(54) SYSTEM AND METHOD FOR SCHEDULING AND TRACKING GOODS IN A TRANSPORTATION NETWORK

(71) Applicant: HCL Technologies Limited, Uttar Pradesh (IN)

(72) Inventors: Hrishikesh KORAD, Noida (IN); Ashar PASHA, Frisco, TX (US); Madhusudhan R M, Chennai (IN)

(21) Appl. No.: 15/424,146

(22) Filed: Feb. 3, 2017

(30) Foreign Application Priority Data
Feb. 9, 2016 (IN) 201611004631

(51) Int. Cl. G06Q 10/08

(52) U.S. Cl. CPC G06Q 10/0833

(57) ABSTRACT

The present disclosure relates to system(s) and method(s) for scheduling and tracking of goods in a transportation network is illustrated. The method may comprise capturing goods data associated with goods received at a terminal and categorizing the goods into a plurality of sets of goods based on the goods data. The method may further comprise maintaining Unit loading device (ULD) data. The method may further comprise identifying a sub-set of Unit loading devices (ULDs), from a set of ULDs, with allocation status as null. The method may further comprise assigning a ULD from the sub-set of ULDs to a set of goods of the plurality of sets of goods, based upon goods data and ULD data. The method may further comprise scheduling the ULD for loading the set of goods based on the goods data and tracking a current location of the set of goods based on the ULD data.

### CROSS-REFERENCE TO RELATED APPLICATIONS AND PRIORITY

The present application claims priority from Indian Patent Application No. 201611004631, filed on Feb. 9, 2016, the entirety of which is hereby incorporated by reference.

### TECHNICAL FIELD

The present disclosure in general relates to the field of logistics. More particularly, the present invention relates to a system and method for scheduling and tracking goods (cargo and baggage) in a transportation network.

### BACKGROUND

Waterways, roadways, and airways are the most prominently user transportation network in the field of logistics and airlines. With the rise in aviation industry, airway is considered as the fastest means for transportation of goods and passengers from one place to another. The aerial transportation networks use passenger as well as cargo aircrafts, whereas the waterway transportation networks use cargo ships for transporting goods from one place to another. Initially, the passenger baggage's and cargos are loaded into Unit Loading Devices (ULD's)/containers. The ULDs/containers are then loaded into the cargo aircraft or ships and transported from source station to destination station.

In case of airlines, at the destination airport, the goods are unloaded from the ULDs at the respective terminal. The empty ULDs are again loaded with new goods and transported from one place to another. Currently, the loading and unloading of ULDs is performed as per the demand forecast given by the individual terminal at the airport. If the terminal receives last minute cargo or baggage, the airlines need to borrow pallets for loading the cargo/baggage into the aircraft or else the cargo/baggage needs to be transported by next available flight if the ULD's are not in stock.

Currently the real time visibility of the goods for transportation is a major concern in the transportation industry. Moreover, the process of scheduling as well as transporting the goods and ULD management is performed manually, which leads to a number of errors in the entire process.

### SUMMARY

This summary is provided to introduce aspects related to systems and methods for scheduling and tracking of goods and ULD in a transportation network and the aspects are further described below in the detailed description. This summary is not intended to identify essential features of the claimed subject matter nor is it intended for use in determining or limiting the scope of the claimed subject matter.

In one embodiment, a system for scheduling and tracking of goods in a transportation network is illustrated. The system is configured to connect with a set of devices installed over a set of Unit Loading Devices (ULDs), wherein each device from the set of devices is installed over a ULD from the set of ULD's. In one embodiment, a device of the set of devices is configured to maintain ULD data comprising geographical location data, temperature data, capacity data, and an allocation status of the ULD. Further, the system comprises a processor coupled to a memory, wherein the processor is configured to execute programmed instructions stored in the memory. The processor may execute a programmed instruction to capture goods data associated with goods received at a terminal, wherein the goods data include carrier data, source data, destination data, weight data, and dimension data. The processor may execute a programmed instruction to categorize the goods into a plurality of sets of goods based on the goods data. Further, the processor may execute a programmed instruction to maintain Unit loading device (ULD) data captured by a set of devices installed on a set of Unit loading devices (ULDs) in a local repository. The processor may execute a programmed instruction to identify a sub-set of ULDs, from the set of ULDs, with allocation status as null. Further, the processor may execute a programmed instruction to assign a ULD from the sub-set of ULDs to a set of goods of the plurality of sets of goods, based upon goods data and ULD data. Further, the processor may execute a programmed instruction to schedule the ULD for loading the set of goods based on the goods data and track a current location of the set of goods based on the ULD data. Furthermore, the processor may execute a programmed instruction to transmit the current location of the goods to a user device.

In one embodiment, a method for scheduling and tracking goods in a transportation network is illustrated. The method may comprise capturing goods data associated with goods received at a terminal, wherein the goods data include carrier data, source data, destination data, weight data, and dimension data. The method may further comprise categorizing the goods into a plurality of sets of goods based on the goods data. The method may further comprise maintaining Unit loading device (ULD) data comprising geographical location data, temperature data, capacity data, and an allocation status of a ULD, wherein the ULD data is captured by a set of devices installed on the set of Unit loading devices (ULDs), wherein each device from the set of devices is installed over a ULD from the set of ULD's. The method may further comprise identifying a sub-set of Unit loading devices (ULDs), from a set of ULDs, with allocation status as null. The method may further comprise assigning a ULD from the sub-set of ULDs to a set of goods of the plurality of sets of goods, based upon goods data and ULD data. The method may further comprise scheduling the ULD for loading the set of goods based on the goods data. The method may further comprise tracking a current location of the set of goods based on the ULD data. The method may further comprise a program code for transmitting the current location of the goods to a user device.

In one embodiment, a non-transitory computer readable medium embodying a program executable in a computing device for scheduling and tracking goods in a transportation network is disclosed. The program comprises a program code for capturing goods data associated with goods received at a terminal, wherein the goods data include carrier data, source data, destination data, weight data, and dimension data. The program comprises a program code for categorizing the goods into a plurality of sets of goods based on the goods data. The program comprises a program code for maintaining Unit loading device (ULD) data comprising geographical location data, temperature data, capacity data, and an allocation status of a ULD, wherein the ULD data is captured by a set of devices installed on the set of Unit loading devices (ULDs), wherein each device from the set of devices is installed over a ULD from the set of ULD's. The program comprises a program code for identifying a sub-set of Unit loading devices (ULDs), from a set of ULDs, with allocation status as null. The program comprises a program code for assigning a ULD from the sub-set of ULDs to a set of goods of the plurality of sets of goods, based upon goods data and ULD data. The program comprises a program code for scheduling the ULD for loading the set of goods based on the goods data. The program comprises a program code for tracking a current location of the set of goods based on the ULD data. The program comprises a program code for transmitting the current location of the goods to a user device.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for scheduling and tracking goods in a transportation network, in accordance with an embodiment of the present subject matter.

FIG. 2 illustrates the system for scheduling and tracking goods in a transportation network, in accordance with an embodiment of the present subject matter.

FIG. 3 illustrates a flow diagram for scheduling and tracking goods in a transportation network using the system, in accordance with an embodiment of the present subject matter.

### DETAILED DESCRIPTION

The present subject matter relates to a system for scheduling and tracking of goods in a transportation network. In a typical transportation network such as aerial transportation network, the goods such as baggage's and cargos are loaded into a set of empty Unit Loading Devices (ULD's). The ULDs with baggage's and cargos are then loaded into a cargo aircraft and transported from source station to destination station. At the destination airport, the goods are unloaded from the ULDs at the respective terminal. After unloading, the empty ULDs are transported either to ULD storages areas (airline equipment area) or to goods loading terminal for loading up new set of goods.

The empty ULDs are again loaded with new goods and transported from one place to another. In order to optimize the movement of the ULDs for loading and unloading of goods, the present system is configured to track individual location of empty ULDs using a set of smart devices that are installed over the ULDs. The smart devices, hereafter referred to as devices are enabled with a set of sensors for capturing real-time information and accordingly schedule the loading and unloading cycle of the ULDs.

For this purpose, the system is configured to connect with a set of devices installed over a set of Unit Loading Devices (ULDs). In one embodiment, a device of the set of devices is configured to capture ULD data comprising geographical location data, temperature data, capacity data, and an allocation status of the ULD. Further, the system comprises a processor coupled to a memory, wherein the processor is configured to execute programmed instructions stored in the memory.

In one embodiment, the processor may execute a programmed instruction to capture goods data associated with goods received at a terminal. The terminal may be an airport check-in terminal in case if baggage's are to be transported. Further, terminal may be an airline cargo warehouse in case if the cargos are to be transported. The goods data may include carrier data, source data, destination data, weight data, and dimension data. The processor may execute a programmed instruction to categorize the goods into a plurality of sets of goods based on the goods data. The goods may be categorised based on common source data and destination data.

Further, the processor may execute a programmed instruction to maintain Unit loading device (ULD) data captured by a set of devices installed on a set of Unit loading devices (ULDs) in a local repository. The ULD data may be captured in real-time and updated at a regular frequency. The processor may execute a programmed instruction to identify a sub-set of ULDs, from the set of ULDs, with allocation status as null.

Further, the processor may execute a programmed instruction for management of the sub-set of ULDs. For the purpose of management of subset of ULDs, the processor may be configured to monitor the current location of each ULD, from the sub-set of ULDs, in real-time. Further, the processor may execute a programmed instruction to assign a ULD from the sub-set of ULDs to a set of goods of the plurality of sets of goods, based upon goods data and ULD data. Further, the processor may be configured to analyse the distance between the current location of each ULD from the sub-set of ULDs and the terminal for loading a set of goods of the plurality of sets of goods. Based on the analysis, the processor is configured to assign one or more ULDs, from the sub-set of ULD, to the terminal for loading the set of goods of the plurality of sets of goods.

Further, the processor may be configured to assign one or more ULDs from the sub-set of ULDs based on a forecasting data associated with a set of goods to be received at the terminal. The forecasting data may be captured at the check-in terminal or may be determined based on the number of booking received for a flight associated with the terminal. Further, based on the forecasting data the appropriate number of ULDs required to accommodate the set of goods at a terminal is determined and accordingly the appropriate number of ULDs is assigned to each terminal.

Further, the processor may execute a programmed instruction to schedule the ULD for loading the set of goods based on the goods data. Further, once the ULD is loaded, the processor is configured to track a current location of the set of goods based on the ULD data received in real-time. Furthermore, the processor may execute a programmed instruction to transmit the current location of the goods to user devices of the owners of the goods. The owners of the goods may then individually view and track the current location of their baggage/cargo.

While aspects of described system and method for scheduling and tracking of goods in a transportation network may be implemented in any number of different computing systems, environments, and/or configurations, the embodiments are described in the context of the following exemplary system.

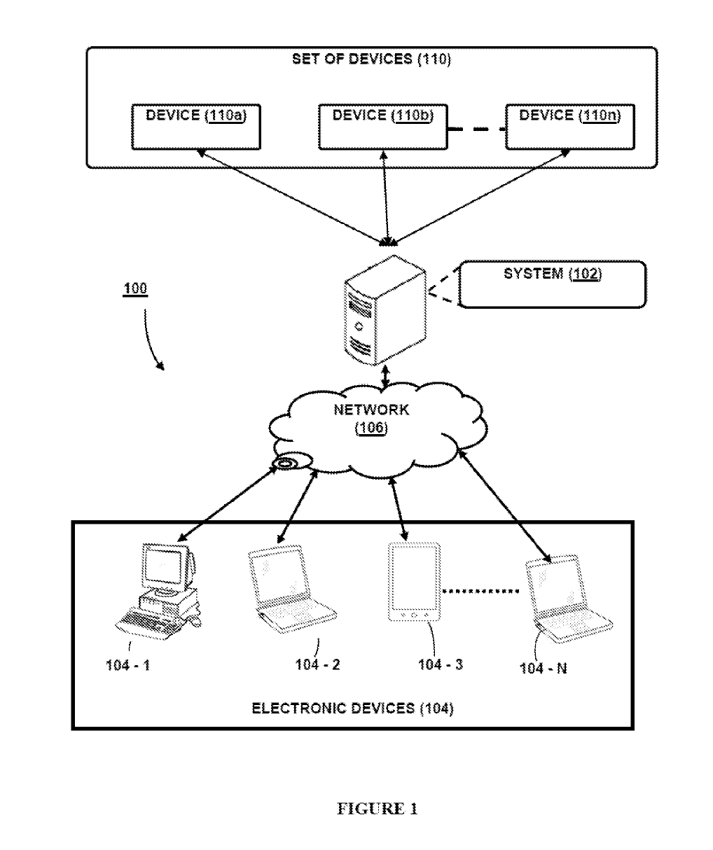

Referring now to FIG. 1, a network implementation 100 of a system 102 for scheduling and tracking of goods in a transportation network is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

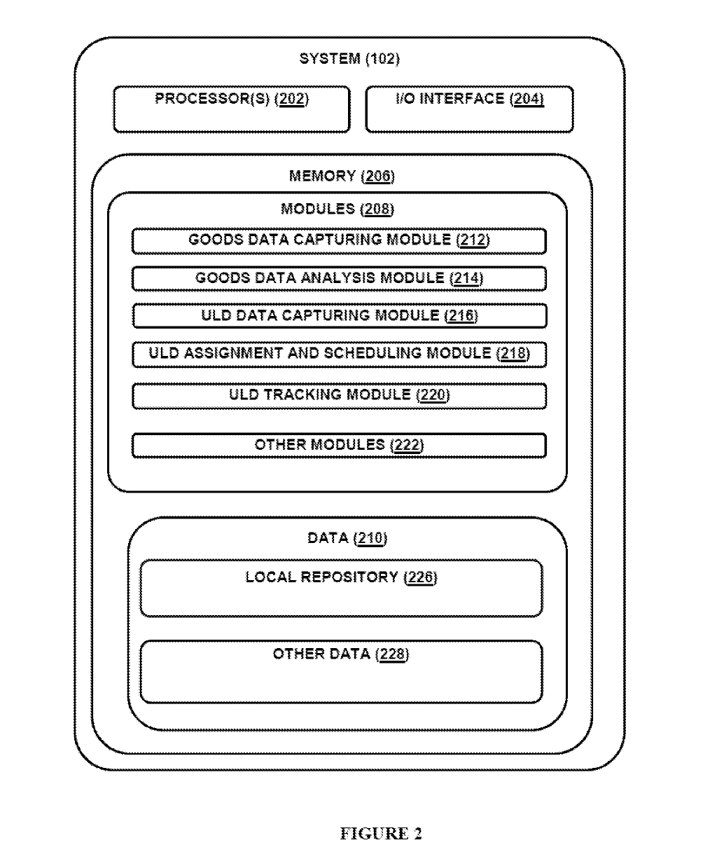

Further, the system 102 is connected to a set of devices 110 installed over a set of Unit Loading Devices (ULDs) through the network 106. In one embodiment, each device from the set of devices 110 is enabled with a set of sensors. The set of sensors are configured to capture Unit loading device (ULD) data comprising geographical location data, temperature data, capacity data, and an allocation status of a ULD. In one embodiment, the system 102 is configured to capture goods data associated with goods received at a terminal. The terminal may be an airport check-in terminal. The goods data and the ULD data are used by the system 102 in order to schedule and track the movement of goods in the transportation network. The process of scheduling and tracking of goods in a transportation network is further elaborated with respect to FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a goods data capturing module 212, goods data analysis module 214, ULD data capturing module 216, ULD assignment and scheduling module 218, ULD tracking module 220, and other modules 222. The other modules 222 may include programs or coded instructions that supplement applications and functions of the system 102. The data 210, amongst other things, serves as a repository for storing data processed, received, and generated by one or more of the modules 208. The data 210 may also include a local repository 226, and other data 228.

In one embodiment, the local repository 226 is configured to store ULD data captured from the set of device 110 installed over a set of ULDs. The ULDs are configured to accommodate the goods to be transported from one place to another. In one embodiment each device from the set of devices 110 is mounted over a ULD from the set of ULDs. The device is connected to a set of sensors including GPS sensor, temperature sensor, occupancy sensor, volume sensor and the like. The set of sensors are configured to capture the ULD data from the set of sensors. The ULD data includes geographical location data, temperature data, capacity data, and an allocation status of the ULD. Once the ULD data is captured by the set of sensors, the system 102 is configured to receive the ULD data from the set of devices 110. Further, the set of devices 110 are configured to monitor the data received from the set of sensors and identify change in temperature or location and accordingly, this information is transmitted to the system 102.

In one implementation, the goods data capturing module 212 is configured to capture goods data associated with goods received at a terminal. In one embodiment, the terminal may be a check-in terminal at an airport. In one embodiment, the goods data may include carrier data, source data, destination data, weight data, and dimension data. In one embodiment, the carrier data is associated with the details of the flight through which the goods are to be transported. Further, the source data is associated with the geographical location of a loading terminal at which the goods are loaded into a ULD, whereas the destination data is associated with the geographical location of the aircraft in which the ULD is to be loaded. Further, the weight data, and the dimension data is associated with each of the goods to be transported.

Once the goods data is captured, in the next step, the goods data analysis module 214 is configured to categorise the goods data into a plurality of sets of goods based on the goods data. In one embodiment, the goods data may be categorized into the plurality of sets of goods based on a common source data and destination data of the goods. For example, if two baggage's are tagged with the same destination information, then the goods data analysis module 214 may categories both the baggage's in a single set of goods.

Once the categorization is over, in the next step, the ULD data capturing module 216 is configured to receive ULD data stored in the local repository 226. In another embodiment, the ULD data may be received in real-time from the set of devices 110. The ULD data comprising geographical location data, temperature data, capacity data, and an allocation status of a ULD. The geographical location data is associated with the real-time location of the ULD, whereas the temperature data is associated with the temperature maintained in the ULD. Further, capacity data is indicative of the weight of goods that can be accommodated in the ULD, whereas the allocation status of the ULD is indicative of the flight or aircraft information to which the ULD is assigned. Further, the ULD data capturing module 216 is configured to identify a sub-set of Unit loading devices (ULDs), from a set of ULDs, with allocation status as null. In other words, the ULD data capturing module 216 is configured to identify the sub-set of ULDs which is not assigned to any of the flights or aircrafts.

Once the sub-set of ULDs is identified, in the next step, the ULD assignment and scheduling module 218 is configured to assign a ULD from the sub-set of ULDs to a set of goods of the plurality of sets of goods. For the purpose of assigning the ULD, the ULD assignment and scheduling module 218 is configured to analyze the goods data and ULD data. In one example, the ULD assignment and scheduling module 218 may analyse the geographical distance between the geographical location data of ULDs and the source data of the set of goods. Based on the minimal distance between the geographical location data of the ULDs and the source data of the set of goods, each set of goods is assigned with ULD.

In one embodiment, the ULD assignment and scheduling module 218 may be configured to assign one or more ULDs from the sub-set of ULDs, to a sub set of goods, based on a forecasting data associated with the set of goods to be received at the terminal. The forecasting data may be captured at the check-in terminal or may be determined based on the number of booking received for a flight associated with the terminal. Further, based on the forecasting data, the appropriate number of ULDs required to accommodate the set of goods at a terminal is determined and accordingly the appropriate number of ULDs is assigned to each terminal.

Further, the ULD assignment and scheduling module 218 is configured to schedule the ULD for loading the set of goods based on the goods data. In one example, the goods data may be analysed to determine the carrier data associated with the set of goods. The carrier data may store the details of the carrier such as flight number, flight timings, which may be used to assign ULD for each set of goods.

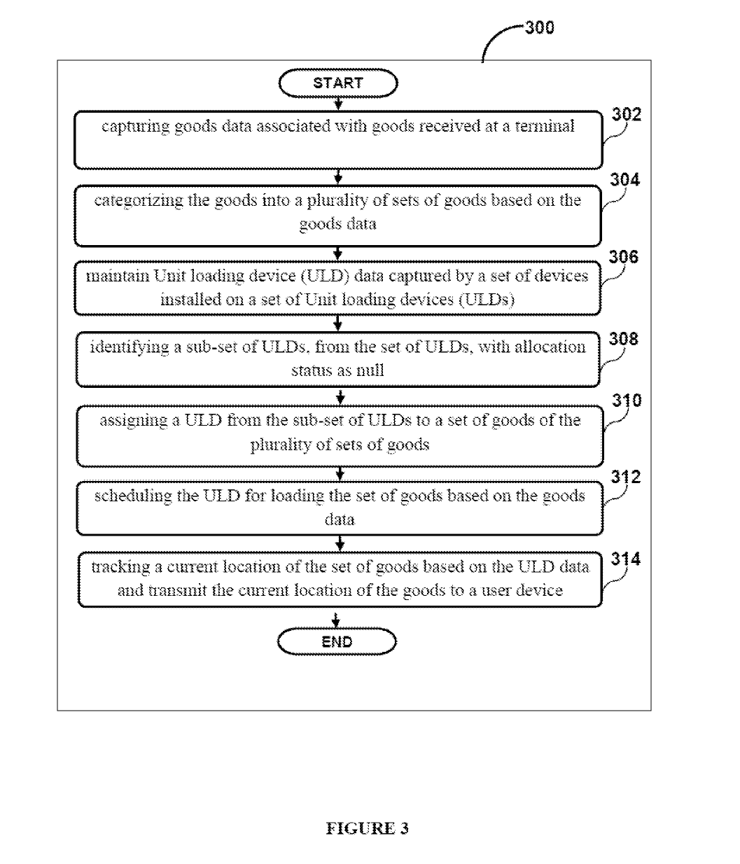

Further, the ULD tracking module 220 enables tracking a current location of the set of goods based on the ULD data received in real-time and transmitting the current location of the goods to a user device 104 of the user. The method for scheduling and tracking of goods in the transportation network is further illustrated with respect to the block diagram of FIG. 3.

Referring now to FIG. 3, a method 300 for scheduling and tracking of goods in a transportation network is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the goods data capturing module 212 is configured to capture goods data associated with goods received at a terminal. In one embodiment, the terminal may be a check-in terminal or airline cargo warehouse at the airport. In one embodiment, the goods data may include carrier data, source data, destination data, weight data, and dimension data. In one embodiment, the carrier data is associated with the details of the aircraft flight through which the goods are to be transported. Further, the source data is associated with the geographical location at which the goods are loaded into a ULD, whereas the destination data is associated with the geographical location of the aircraft in which the goods are to be loaded. Further, the weight data, and the dimension data is associated with each of the goods to be transported.

At block 304, once the goods data is captured, in the next step, the goods data analysis module 214 is configured to categorise the goods data into a plurality of sets of goods based on the goods data. In one embodiment, the goods data may be categorized into the plurality of sets of goods based on a common source data and destination data of the goods. For example, if two baggage's are tagged with the same destination information, then the goods data analysis module 214 may categories both the baggage's in a single set of goods.

At block 306, once the categorization is over, in the next step, the ULD data capturing module 216 is configured to receive ULD data stored in the local repository 226. In another embodiment, the ULD data may be received in real-time from the set of devices 110. The ULD data comprising geographical location data, temperature data, capacity data, and an allocation status of a ULD. The geographical location data is associated with the real-time location of the ULD, whereas the temperature data is associated with the temperature maintained in the ULD. Further, capacity data is indicative of the weight of goods that can be accommodated in the ULD, whereas the allocation status of the ULD is indicative of the flight or aircraft information to which the ULD is assigned.

At block 308, the ULD data capturing module 216 is configured to identify a sub-set of Unit loading devices (ULDs), from a set of ULDs, with allocation status as null. In other words, the ULD data capturing module 216 is configured to identify the sub-set of ULDs which is not assigned to any of the flights or aircrafts.

At block 310, once the sub-set of ULDs is identified, in the next step, the ULD assignment and scheduling module 218 is configured to assign a ULD from the sub-set of ULDs to a set of goods of the plurality of sets of goods. For the purpose of assigning the ULD, the ULD assignment and scheduling module 218 is configured to analyze the goods data and ULD data. In one example, the ULD assignment and scheduling module 218 may analyse the geographical distance between the geographical location data of ULDs and the source data of the set of goods. Based on the minimal distance between the geographical location data of the ULDs and the source data of the set of goods, each set of goods is assigned with a ULD.

At block 312, the ULD assignment and scheduling module 218 is configured to schedule the ULD for loading the set of goods based on the goods data. In one example, the goods data may be analysed to determine the carrier data associated with the set of goods. The carrier data may store the details of the carrier such as flight number, flight timings, which may be used to assign ULD for each set of goods.

At block 314, the ULD tracking module 220 enables tracking a current location of the set of goods based on the ULD data received in real-time and transmitting the current location of the goods to a user device 104 of the user.

Although implementations for methods and systems for scheduling and tracking of goods in a transportation network has been described, it is to be understood that the appended claims are not necessarily limited to the specific features or methods described. Rather, the specific features and methods are disclosed as examples of implementations for scheduling and tracking of goods.

We claim:

1. A system for scheduling and tracking goods in a transportation network, the system comprising:
a memory; and
a processor coupled to the memory, wherein the processor is configured to execute program instructions stored in the memory to:
capture goods data associated with goods received at a terminal, wherein the goods data include carrier data, source data, destination data, weight data, and dimension data;
categorize the goods into a plurality of sets of goods based on the goods data;
maintain Unit loading device (ULD) data comprising geographical location data, temperature data, capacity data, and an allocation status of a ULD, wherein the ULD data is captured by a set of devices installed on a set of Unit loading devices (ULDs);
identify a sub-set of ULDs, from the set of ULDs, with allocation status as null;
assign a ULD from the sub-set of ULDs to a set of goods of the plurality of sets of goods, based upon goods data and ULD data;
schedule the ULD for loading the set of goods based on the goods data;
track a current location of the set of goods based on the ULD data; and
transmit the current location of the goods to a user device.

2. The system of claim 1, wherein the goods include baggage's or cargos.

3. The system of claim 1, wherein the device from the set of devices is configured to collect geographical location data and temperature data of the ULD in real-time using a GPS sensor and a temperature sensor respectively.

4. The system of claim 1, wherein the source data is associated with a station of the terminal for loading the ULD with the set of goods, and destination data is associated with the location of the carrier for loading the ULD.

5. The system of claim 1, wherein the user device is configured to display the current location of the goods over a graphical interface.

6. A method for scheduling and tracking goods in a transportation network, the method comprising steps of:
capturing, by a processor, goods data associated with goods received at a terminal, wherein the goods data include carrier data, source data, destination data, weight data, and dimension data;
categorizing, by the processor, the goods into a plurality of sets of goods based on the goods data;
maintaining, by a processor, Unit loading device (ULD) data comprising geographical location data, temperature data, capacity data, and an allocation status of a ULD, wherein the ULD data is captured by a set of devices installed on the set of Unit loading devices (ULDs);
identifying, by the processor, a sub-set Unit loading devices (ULDs), from a set of ULDs, with allocation status as null;
assigning, by the processor, a ULD from the sub-set of ULDs to a set of goods of the plurality of sets of goods, based upon goods data and ULD data;
scheduling, by the processor, the ULD for loading the set of goods based on the goods data;
tracking, by the processor, a current location of the set of goods based on the ULD data; and
transmitting, by the processor, the current location of the goods to a user device.

7. The method of claim 6, wherein the goods include baggages or cargos.

8. The method of claim 6, wherein a device from the set of devices is configured to collect geographical location data and temperature data of the ULD in real-time using a GPS sensor and a temperature sensor respectively.

9. The method of claim 6, wherein the source data is associated with a station of the terminal for loading the ULD with the set of goods, and destination data is associated with the location of the carrier for loading the ULD.

10. The method of claim 6, wherein the user device is configured to display the current location of the goods over a graphical interface.

11. A non-transitory computer readable medium embodying a program executable in a computing device for scheduling and tracking goods in a transportation network, the computer program product comprising:
a program code for capturing goods data associated with goods received at a terminal, wherein the goods data include carrier data, source data, destination data, weight data, and dimension data;
a program code for categorizing the goods into a plurality of sets of goods based on the goods data;
a program code for maintaining Unit loading device (ULD) data comprising geographical location data, temperature data, capacity data, and an allocation status of a ULD, wherein the ULD data is captured by a set of devices installed on the set of Unit loading devices (ULDs);
a program code for identifying a sub-set Unit loading devices (ULDs), from a set of ULDs, with allocation status as null;
a program code for assigning a ULD from the sub-set of ULDs to a set of goods of the plurality of sets of goods, based upon goods data and ULD data;
a program code for scheduling the ULD for loading the set of goods based on the goods data;
a program code for tracking a current location of the set of goods based on the ULD data; and
a program code for transmitting the current location of the goods to a user device.
